(19) United States
(12) Patent Application Publication
(10) Pub. No.: US 2020/0321631 A1
(43) Pub. Date: Oct. 8, 2020

(54) ACTIVATABLE BATTERY, ELECTRONIC IGNITER, PROCESS FOR PRODUCING AN ACTIVATABLE BATTERY AND METHOD OF USING AN UNSUPPORTED FILM IN A BATTERY

(71) Applicant: DIEHL & EAGLE PICHER GMBH, Roethenbach (DE)

(72) Inventor: ROLAND HEIN, NUERNBERG (DE)

(21) Appl. No.: 16/826,503

(22) Filed: Mar. 23, 2020

(30) Foreign Application Priority Data
Apr. 5, 2019 (DE) 10 2019 002 504

(51) Int. Cl. H01M 6/32; H01M 6/16; H01M 2/16; H01M 4/08; H01M 4/38; H01M 4/587

(52) U.S. Cl. CPC H01M 6/32; H01M 6/164; H01M 6/166; H01M 2300/0031; H01M 4/08; H01M 4/382; H01M 4/587; H01M 2/1613

(57) ABSTRACT

An activatable battery includes at least one cathode, at least one anode, at least one absorptive separator layer in contact with the anode and the cathode and a liquid electrolyte separated therefrom and provided in an apparatus which liberates the electrolyte in order to activate the battery in such a way that it comes into contact with the separator layer and penetrates through the latter at least to such an extent that the electrolyte electrically connects the anode and the cathode to one another. The anode is formed of lithium or a lithium-containing alloy and the cathode includes elemental carbon and is formed of an unsupported film including carbon nanotubes or of a film formed of carbon nanotubes. An electronic igniter, a process for producing an activatable battery and a method of using a film in a battery are also provided.

### CROSS-REFERENCE TO RELATED APPLICATION

This application claims the priority, under 35 U.S.C. § 119, of German Patent Application DE 10 2019 002 504, filed Apr. 5, 2019; the prior application is herewith incorporated by reference in its entirety.

### BACKGROUND OF THE INVENTION

### Field of the Invention

The invention relates to an activatable electric battery having at least one cathode, at least one anode, at least one absorptive separator layer which is disposed between the anode and cathode and is in contact with the anode and the cathode and a liquid electrolyte separated therefrom. The electrolyte is provided in an apparatus which liberates the electrolyte in order to activate the battery in such a way that it comes into contact with the separator layer and penetrates through the latter to at least such an extent that the electrolyte electrically connects the anode and the cathode to one another and forms an electrochemical cell. The anode is formed of lithium or of a lithium-containing alloy, i.e. an alloy which can liberate lithium ions. The cathode includes elemental carbon. The invention also relates to an electronic igniter, a process for producing an activatable battery and a method of using a film in a battery.

An activatable battery of that type is known as activatable lithium-thionyl chloride battery, in particular as a battery for an electronic munitions igniter. In such a battery, SOCl₂ as a liquid electrolyte is kept in storage in a closed vessel. As a result, the electrodes are not in contact with the electrolyte, so that neither a discharge nor a chemical degradation process can occur. That ensures that the battery can reliably provide electric power even after a long storage time. In order to activate the battery, the closed vessel is opened or destroyed, so that the electrolyte is liberated and becomes distributed in the separator layer between the cathode and the anode. That forms an electrochemical cell, also referred to as a galvanic cell or an electrode cell, including the cathode, the separator layer and the anode. When the battery is present in a projectile for supplying electric power to an igniter of the projectile, acceleration forces occurring upon firing and any rotation occurring assist distribution of the electrolyte. The separator layer prevents direct electrical contact between the cathode and the anode, so that an electrically conductive connection can be established only by using the electrolyte.

The elemental carbon of the cathode is usually originally present in powder form. In order to produce the cathode, the carbon powder is generally provided with a binder and either applied by a wet coating process to a metal foil which conducts away the electric current or pressed in a mold. In both cases, drying is subsequently carried out. It is also possible for the dried elemental carbon which has been provided with the binder to be sintered, milled and subsequently pressed to provide a disc. In any case, production of the electrode including elemental carbon is comparatively complicated. In addition, a battery including such a cathode including elemental carbon takes a certain time to provide a desired voltage and current having a desired strength after contact with the electrolyte in an electrode cell.

U.S. Patent Application Publication No. 2011/0163274 A1 discloses an electrode composition for a negative electrode of a secondary lithium ion battery having a nonaqueous electrolyte. The electrode composition contains at least one mixture containing carbon nanofibers and carbon nanotubes as a conductive additive. Furthermore, the electrode composition contains an active element which displays electrochemical activity and a binder.

Nomura, et al., Sci Rep. 2017, Apr. 5; 7:45596, discloses the use of a flexible sheet composed of carbon nanotubes as an electrode for a rechargeable lithium-air battery.

Kim, Sang Woo & Cho, Kuk. (2015), Journal of Electrochemical Science and Technology, 6(1), 10-15, discloses the use of materials based on carbon nanotubes as flexible power outlet leads in lithium ion batteries.

### BRIEF SUMMARY OF THE INVENTION

It is accordingly an object of the invention to provide an alternative activatable battery, which overcomes the hereinafore-mentioned disadvantages of the heretofore-known batteries of this general type, which is comparatively simple to produce and in which the time between contact of the electrolyte with the electrodes and the provision of a desired voltage and of current having a desired strength is comparatively short. Furthermore, an electronic igniter, a process for producing the activatable battery and a method of using a film in a battery are to be indicated.

With the foregoing and other objects in view there is provided, in accordance with the invention, an activatable battery having at least one cathode, at least one anode, at least one absorptive separator layer which is disposed between the anode and the cathode and is in contact with the anode and the cathode and also a liquid electrolyte separated therefrom. The electrolyte is provided in an apparatus which liberates the electrolyte in order to activate the battery in such a way that it comes into contact with the separator layer and penetrates through the latter at least to such an extent that the electrolyte electrically connects the anode and the cathode to one another. In this case, the anode is formed of lithium or a lithium-containing alloy. The cathode includes elemental carbon. The cathode is formed of an unsupported film including carbon nanotubes or of a film formed of carbon nanotubes. For the purposes of the present invention, an unsupported film is a film in which a composition including carbon nanotubes has not been applied to a support which does not include any carbon nanotubes, for example a metal foil. The unsupported film accordingly does not include any support material which is free of carbon nanotubes.

Such a film is usually referred to as CNT film. CNT is the conventional abbreviation for “carbon nanotubes.” CNT films are commercial. They are used, for example, as films for producing electric shielding or for increasing the strength of a carbon fiber-reinforced polymer. The film has the advantage of good commercial availability and the fact that it can be processed simply, for example by using laser cutting or stamping. The complicated production of the cathodes containing elemental carbon which have heretofore been used is dispensed with. Cutting by using a laser makes it possible to cut out electrodes of any shape. Furthermore, the deformability of the cathode produced from the film makes it possible to construct flexible batteries and to construct batteries of any shape. In addition, the cathode can as a result be provided with a particularly high surface area and thus a large contact area with the electrolyte in a comparatively small space. For this purpose, the film can, for example, be provided in a meandering fashion or in pleated form in the electrode cell. This would not be possible, or be possible only with great difficulty, when using the previously customary cathodes containing elemental carbon.

In one embodiment of the activatable battery of the invention, the carbon nanotubes are joined to one another only by interactions between the carbon nanotubes. A binder is not present between the carbon nanotubes in this embodiment. The film can, for example, be in the form of a nonwoven. Such a film is marketed, for example, by Tortech Nano Fibers Ltd., Israel. As a result of the absence of the binder, this film has a particularly low internal resistance. A high battery power of the activatable battery is achieved thereby. Furthermore, the battery power is attained particularly quickly after electrical connection of the anode and cathode by using the electrolyte due to the low internal resistance. A particularly quick buildup of the voltage results and the battery is able to release energy particularly quickly after it has been activated due to the low internal resistance.

In a further embodiment, the film is formed to an extent of more than 80% by weight, in particular more than 90% by weight, in particular more than 95% by weight, in particular more than 98% by weight, in particular more than 99% by weight, in particular exclusively, of the carbon nanotubes. This makes an extremely low internal resistance with the above-mentioned advantages of rapid voltage buildup and the possibility of quick energy release after activation of the battery possible. This is of particular importance in the case of activatable batteries for electric power supply to igniters and/or control devices of projectiles, in the case of which activation of the battery usually occurs only after firing of the projectile and in the case of which the electric energy should be available very quickly after firing.

The anode can be in the form of a further film. This allows simple production of electrode cells formed in each case by the cathode, the separator layer and the anode by placing the film, the separator layer and the further film on top of one another. For this purpose, the film, the separator layer and the further film can each be rolled off from a roll, joined and then cut or stamped. As a result of both electrodes being configured as films, the electrodes are very easy to bring to a desired shape. The superposed electrodes with a separator layer disposed in between can, for example, optionally be rolled up with an insulating film disposed in between in order to accommodate comparatively large electrode areas in a relatively small space.

In one embodiment, the battery has a plurality of electrode cells each formed by the cathode, the separator layer and the anode, with a plurality of the electrode cells being assembled to form a stack. In at least two of the electrode cells, the cathode of one of the electrode cells can in each case be electrically connected to the cathode of another of the electrode cells and the anode of one of the electrode cells can in each case be electrically connected to the anode of another of the electrode cells. The individual electrode cells are connected in parallel. This increases the capacity of the battery while the voltage thereof remains constant. The cathode and the anode of adjacent electrode cells can in each case be electrically insulated from one another by an insulator, for example in the form of a polymer film.

It is also possible, in at least two of the electrode cells, for the cathode of one of the electrode cells to be electrically connected in each case to the anode of another of the electrode cells. The individual electrode cells are in this case connected in series. In this case, one anode and one cathode of each of the electrode cells connected in series are not electrically connected to a cathode or anode of another of the electrode cells. This anode and this cathode in each case serve to collect current from the electrode cells connected in series. The series configuration of the electrode cells increases the voltage of the battery while the capacity thereof remains constant. A mixed form in which some of the electrode cells are connected in parallel, with at least two of the electrode cells connected in parallel then being connected in series, is also possible.

The electrolyte can include thionyl chloride (SOCl₂) and an electrolyte salt or can be formed of thionyl chloride (SOCl₂) and an electrolyte salt. The thionyl chloride can simultaneously serve as a solvent. The electrolyte salt can be lithium tetrachloroaluminate (LiAlCl₄).

The separator layer can be formed of a nonwoven or include a nonwoven. It is possible for the nonwoven to be formed of glass fibers or include glass fibers.

With the objects of the invention in view, there is also provided an electronic igniter, wherein the igniter is supplied with electric power by an activatable battery according to the invention.

With the objects of the invention in view, there is furthermore provided a process for producing an activatable battery, wherein an unsupported film including carbon nanotubes or a film formed of carbon nanotubes as a cathode is brought into contact with an absorptive separator layer for taking up a liquid electrolyte. The separator layer is in turn brought into contact with an anode composed of lithium or a lithium-containing alloy. The electrolyte is provided separately in an apparatus which can liberate the electrolyte in order to activate the battery in such a way that it comes into contact with the separator layer and penetrates through the latter at least to such an extent that the anode and the cathode are electrically connected to one another by the electrolyte. The cathode is stamped out from the film or cut out by using a laser beam or cut off from the film, in particular by using a laser beam or a cutter. The process makes significantly simpler and thus cheaper production of the activatable battery of the invention possible as a result of the very simple possible way of producing the cathode.

The production of the battery of the invention is particularly efficient when the film forming the cathode is brought into contact with the separator layer and the separator layer is brought into contact with a further film which is composed of the lithium or the lithium-containing alloy and forms the anode, and electrode cells including the cathode, the separator layer and the anode are stamped out or cut off together by using a single stamping operation or cutting operation from the film, separator layer and further film which have been disposed on top of one another in this way. A large number of electrode cells can be produced very quickly and inexpensively by using such a process.

In an automated process, the film, the separator layer and the further film can, for example, each be rolled off from a roll and then combined. The electrode cells can then easily be stamped out or cut off from the sandwich-like composite formed in this way. It is also possible for a plurality of electrode cells to be stamped out simultaneously by using a stamping operation.

A plurality of the electrode cells can be assembled to form a stack. In at least two of the electrode cells, the cathode of one of the electrode cells can in each case be electrically connected to the cathode of another of the electrode cells and the anode of one of the electrode cells can in each case be electrically connected to the anode of another of the electrode cells. The electrode cells are connected in parallel in such a case. The cathode and the anode of adjacent electrode cells can in each case be electrically insulated from one another by an insulator, for example in the form of a polymer film. It is also possible, in at least two of the electrode cells, for the cathode of one of the electrode cells to be electrically connected in each case to the anode of another of the electrode cells. This can, for example, be effected by the electrode cells simply being stacked on top of one another in the same orientation, so that there is direct electrical contact between one of the anodes and the adjacent cathode. The electrode cells are connected in series in such a case.

When two electrode cells are connected in parallel, it is not absolutely necessary for the electrode cells to be electrically insulated from one another for this purpose. It is also possible for an anode of one of the electrode cells to be stacked directly on top of an anode of another of the electrode cells, so that direct electrical contact is thereby established between the anodes of the two electrode cells. It is likewise possible for the cathode of one of the electrode cells to be stacked directly on top of the cathode of another of the electrode cells, so that direct electrical contact is thereby established between the cathodes of the two electrode cells. In both of the cases mentioned, it is also possible for the electrodes which are in direct contact with one another to be replaced in each case by a single electrode.

With the objects of the invention in view, there is concomitantly provided a method of using of an unsupported film including carbon nanotubes or a film formed of carbon nanotubes as an electrode in a lithium ion battery. The lithium ion battery can be a primary or secondary lithium ion battery.

Other features which are considered as characteristic for the invention are set forth in the appended claims.

Although the invention is illustrated and described herein as embodied in an activatable battery, an electronic igniter, a process for producing an activatable battery and a method of using an unsupported film in a battery, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, vertical-sectional view of an activatable battery according to the invention;

FIG. 2 is an enlarged, fragmentary, vertical-sectional view of an electrode cell stack of the activatable battery with a diagrammatic depiction of an electrode cell; and

FIG. 3 is a view similar to FIG. 2 of an electrode cell stack of the activatable battery with a diagrammatic depiction of a process for producing the electrode cells.

### DETAILED DESCRIPTION OF THE INVENTION

Referring now to the figures of the drawings in detail and first, particularly, to FIG. 1 thereof, there is seen a diagrammatic depiction of an activatable battery 10 for supplying electric power to an igniter of a projectile. When the projectile is fired, a trigger unit 18 is activated. This as a result damages an electrolyte container 16, so that an electrolyte 17 present therein can exit. The acceleration upon firing of the projectile presses an additional mass 12 against the electrolyte container 16 via a damping element 14. As a result, the electrolyte 17 is at least substantially squeezed out from the electrolyte container 16. The electrolyte 17 therefore comes into contact with respective separator layers 24 of electrode cells 21 of an electrode cell stack 20. The separator layers are permeated by the electrolyte 17 or impregnated by the electrolyte 17. An anode 22 and the cathode 26 are electrically connected to one another by the electrolyte.

When the activated battery 10 is discharged, lithium is anodically oxidized with a release of electrons to form lithium ions (Li+) which in turn react to form lithium chloride. In a plurality of reaction steps, thionyl chloride is cathodically reduced to elemental sulfur. This also forms sulfur dioxide. The overall equation can be formulated as follows:

4Li+2SOCl₂→4LiCl+S+SO₂

The reaction products which are formed cathodically deposit in intermediate spaces and channels of the carbon cathode. Sulfur dioxide partly dissolves in the electrolyte 17. Lithium chloride formed anodically deposits in crystalline form on the anode 22.

The electrode cells 21 are stacked directly on top of one another without insulation in between in the electrode cell stack 20 depicted herein, so that there is direct electrical contact between the anode 22 of one of the electrode cells 21 and the cathode 26 of the adjacent electrode cell 21 and the electrode cells 21 are thereby connected in series. The seven electrode cells 21 stacked on top of one another as depicted herein thus generate seven times the voltage of one of the electrode cells 21 in the electrode cell stack 20.

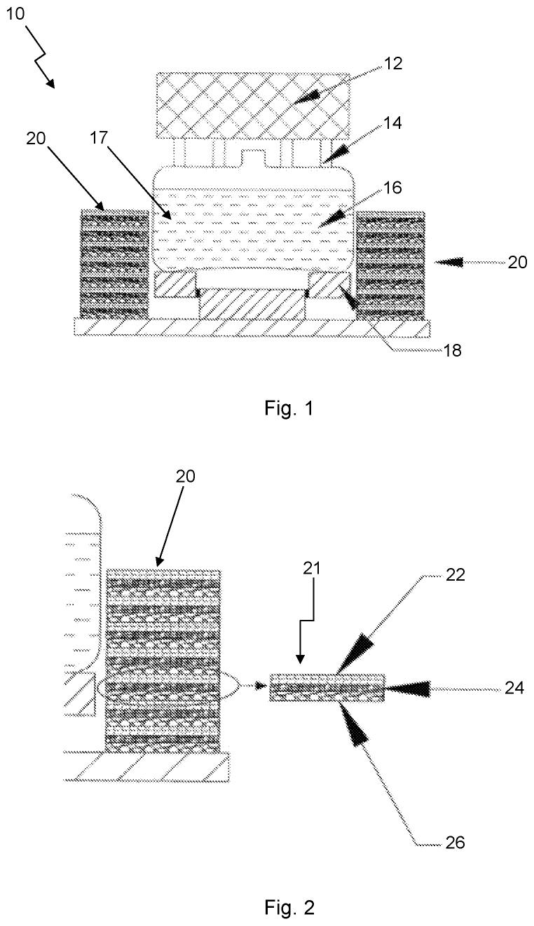

FIG. 2 diagrammatically shows the structure of one of the electrode cells 21 made up of the anode 22, the separator layer 24 and the cathode 26.

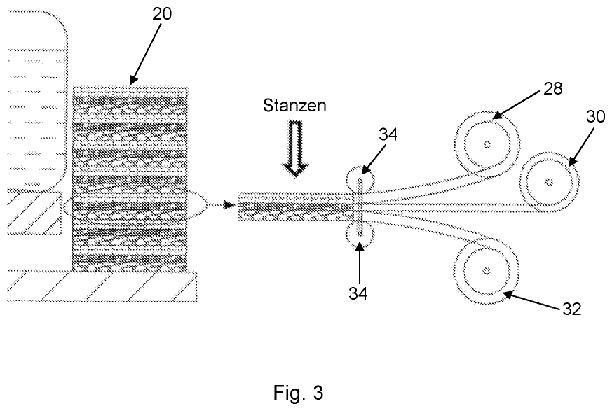

FIG. 3 diagrammatically shows a process for producing the electrode cells 21. In this case, a rolled-up lithium foil 28, a rolled-up separator layer 30 and a rolled-up CNT film 32 are each rolled off from a roll and pressed together by two pressing rollers 34 to provide a layer composite. The electrode cells 21 are stamped out from this layer composite by stamping which is indicated by an arrow. The electrode cells 21 which are thus obtained can then be assembled to form the electrode cell stack 20.

### LIST OF REFERENCE NUMERALS

10 Activatable battery
12 Additional mass
14 Damping element
16 Electrolyte container
17 Electrolyte
18 Trigger unit
20 Electrode cell stack
21 Electrode cell
22 Anode
24 Separator layer
26 Cathode
28 Rolled-up lithium foil
30 Rolled-up separator layer
32 Rolled-up CNT film
34 Pressing roller

1. An activatable battery, comprising:
at least one cathode including elemental carbon and being formed of an unsupported film including carbon nanotubes or a film formed of carbon nanotubes;
at least one anode formed of lithium or a lithium-containing alloy;
at least one absorptive separator layer disposed between said anode and said cathode and being in contact with said anode and said cathode;
a liquid electrolyte being separated from said anode, said cathode and said at least one absorptive separator layer; and
an apparatus receiving said electrolyte and configured to liberate said electrolyte to activate the battery by causing said electrolyte to come into contact with said separator layer and to penetrate through said separator layer at least to an extent causing said electrolyte to electrically conductively connect said anode and said cathode to one another.

2. The activatable battery according to claim 1, wherein said carbon nanotubes are joined to one another only by interactions between said carbon nanotubes.

3. The activatable battery according to claim 1, wherein said film is formed of from more than 80% to 100% by weight of said carbon nanotubes.

4. The activatable battery according to claim 1, wherein said film is formed of more than 90% by weight of said carbon nanotubes.

5. The activatable battery according to claim 1, wherein said film is formed of more than 95% by weight of said carbon nanotubes.

6. The activatable battery according to claim 1, wherein said film is formed of more than 98% by weight of said carbon nanotubes.

7. The activatable battery according to claim 1, wherein said film is formed of more than 99% by weight of said carbon nanotubes.

8. The activatable battery according to claim 1, wherein said anode is a further film.

9. The activatable battery according to claim 1, which further comprises:
a plurality of electrode cells each being formed of one cathode, one separator layer and one anode;
said plurality of electrode cells being assembled to form a stack; and
in at least two of said electrode cells, said cathode of one of said electrode cells being electrically connected to said cathode of another of said electrode cells and said anode of one of the electrode cells being electrically connected to said anode of another of said electrode cells, or
in at least two of said electrode cells, said cathode of one of said electrode cells being electrically connected to said anode of another of said electrode cells.

10. The activatable battery according to claim 9, wherein:
said cathode of one of said electrode cells is electrically connected to said cathode of another of said electrode cells and said anode of one of said electrode cells is electrically connected to said anode of another of said electrode cells; and
said cathode and said anode of adjacent electrode cells are electrically insulated from one another by an insulator.

11. The activatable battery according to claim 1, wherein said electrolyte includes thionyl chloride and an electrolyte salt, or said electrolyte is formed of thionyl chloride and an electrolyte salt.

12. The activatable battery according to claim 11, wherein said electrolyte salt is lithium tetrachloroaluminate.

13. The activatable battery according to claim 1, wherein said separator layer is formed of a nonwoven or includes a nonwoven.

14. The activatable battery according to claim 13, wherein said nonwoven is formed of glass fibers or includes glass fibers.

15. An electronic igniter assembly, comprising an electronic igniter being supplied with electric power by the activatable battery according to claim 1.

16. A process for producing an activatable battery, the process comprising the following steps:
bringing an unsupported film including carbon nanotubes or a film formed of carbon nanotubes forming a cathode into contact with an absorptive separator layer for taking up a liquid electrolyte;
bringing the separator layer into contact with an anode composed of lithium or a lithium-containing alloy;
providing the electrolyte separately from the anode, the separator layer and the cathode in an apparatus for liberating the electrolyte to activate the battery;
using the apparatus to liberate the electrolyte by causing the electrolyte to come into contact with the separator layer and penetrate through the separator layer at least to an extent causing the anode and the cathode to be electrically conductively connected to one another by the electrolyte; and
stamping or cutting the cathode from the film by using a laser beam or cutting off the cathode from the film.

17. The process according to claim 16, which further comprises:
bringing the film forming the cathode into contact with the separator layer and bringing the separator layer into contact with a further film composed of the lithium or the lithium-containing alloy and forming the anode; and
stamping-out or cutting-off electrode cells including the cathode, the separator layer and the anode together in a single stamping operation or cutting operation from the film, the separator layer and the further film disposed on top of one another.

18. The process according to claim 17, which further comprises:
assembling a plurality of the electrode cells to form a stack;
in at least two of the electrode cells, electrically connecting the cathode of one of the electrode cells to the cathode of another of the electrode cells and electrically connecting the anode of one of the electrode cells to the anode of another of the electrode cells, or
in at least two of the electrode cells, electrically connecting the cathode of one of the electrode cells to the anode of another of the electrode cells.

19. The process according to claim 18, which further comprises:
in at least two of the electrode cells, electrically connecting the cathode of one of the electrode cells to the cathode of another of the electrode cells and electrically connecting the anode of one of the electrode cells to the anode of another of the electrode cells; and
electrically insulating the cathode and the anode of adjacent electrode cells from one another by using an insulator.

20. A method of using a film in a lithium ion battery, the method comprising the following step:
using an unsupported film including carbon nanotubes or using a film formed of carbon nanotubes as an electrode in the lithium ion battery.
